(19) United States
(12) Patent Application Publication
(10) Pub. No.: US 2004/0172659 A1
(43) Pub. Date: Sep. 2, 2004

(54) Arrangement for reduction of noise transmitted from a local cable tv network

(76) Inventors: Kjell Arne Ljungdahl, Saltsjoe-Boo (SE); Bo Peter Cullblom, Lidingoe (SE); Lars A. P. Carlsson, Saltsjoe-Boo (SE)

Correspondence Address: CROWELL & MORING LLP, INTELLECTUAL PROPERTY GROUP, P.O. BOX 14300, WASHINGTON, DC, 20044-4300, US

(21) Appl. No.: 10/483,591

(22) PCT Filed: Jul. 12, 2002
(86) PCT No.: PCT/SE02/01377

(30) Foreign Application Priority Data
Jul. 13, 2001 (SE) 0102523-8

(51) Int. Cl. H04N 7/173; H04N 5/52; H04N 17/02; H04N 17/00

(52) U.S. Cl. 725/124; 725/125; 348/683; 348/180; 348/192

(57) ABSTRACT

An arrangement for the reduction of noise transmitted in the return direction fron a local cable TV network (10) comprises an input (14), an output (16), means (21) for evaluating signals incoming at the input (14), and blocking means (17) controllable by said evaluation means (21). Said blocking means are formed by a reprogrammable digital signal processing unit (17), which is connected to the input (14) via an analog-to-digital converter (19) and which is arranged to generate digital output signals corresponding to portions of the incoming signals, depending upon the existing programming of the signal processing unit (17) and the result of the evaluation of the incoming signals effected by the evaluation means (21), and to deliver said digital output signals to a digital-to-analog converter (24) connected to the output (16).

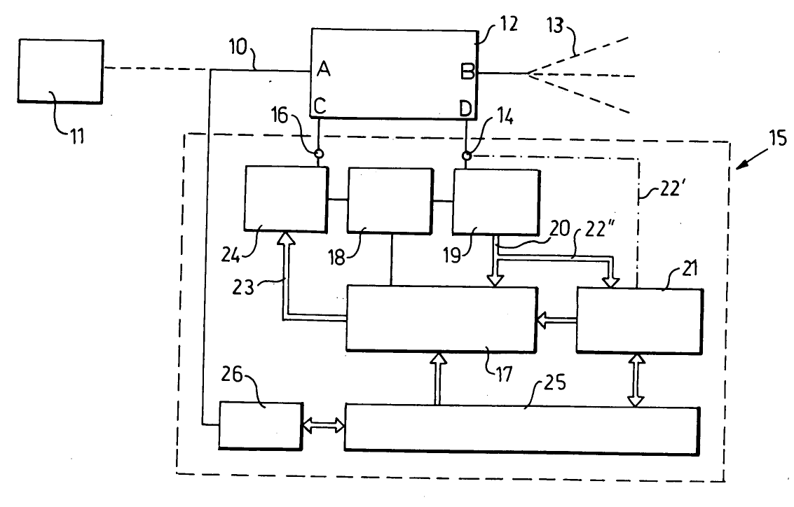

The present invention relates to an arrangement for the reduction of noise transmitted from a local cable TV network within a carrier frequency band serving for the transmission of signals in the return direction from subscriber lines contained in said network to a headend connected to the network.

More particularly, the invention relates to such an arrangement of the kind comprising an input intended to be connected to the subscriber lines, an output intended to be connected to the headend, means for evaluating signals incoming at the input, and blocking means controllable by said evaluation means and arranged to permit or prevent a transmission of signals corresponding to the incoming signals at the output in dependence upon the evaluation of the incoming signals effected by the evaluation means.

A disadvantage of previously known noise reduction arrangements of said kind is that it is not possible in an easy manner to vary the function and manner of operation of said arrangements in view of individual requirements of different cable TV systems. Nor is it possible, after the installation of said arrangements, to change their function and manner of operation in an easy manner in order to adapt them to new or altered requirements later on presented by individual system operators.

The invention has for its purpose to provide a new and improved noise reduction arrangement of the kind initially specified, wherein the above-mentioned disadvantages of the known arrangements can be avoided.

The arrangement according to the invention proposed for said purpose is primarily characterized in that said blocking means are formed by a reprogrammable digital signal processing unit, which is connected to the input via an analog-to-digital converter in order hereby to receive the incoming signals in a sampled digital form and which is arranged to generate digital output signals corresponding to portions of the incoming signals, depending upon the existing programming of the signal processing unit and the result of the evaluation of the incoming signals effected by the evaluation means, and to deliver said digital output signals to a digital-to-analog converter connected to the output.

As a consequence of the above construction of the arrangement, it is possible in connection with the installation of the arrangement easily to adapt its function and manner of operation to the existing requirements of the installation location simply by programming the digital signal processing unit in a corresponding manner. This means that the arrangement may be produced and delivered in a standard design. Furthermore, if new of altered requirements in respect of the function and manner of operation of the arrangement are presented at a later stage, it is easy to adapt the arrangement to said requirements simply by correspondingly reprogramming the signal processing unit. In this connection, it should be mentioned that the arrangement may preferably be arranged to permit a remote controlled programming or reprogramming, respectively, of the signal processing unit.

The arrangement according to the invention also offers the specific advantage of making it possible by programming the signal processing unit in an appropriate manner to bring said unit to act as a frequency converter which is capable of causing a change in the carrier frequency of an incoming signal during the passage of said signal in digital form through said unit.

Furthermore, by appropriately programming the signal processing unit, it is possible to bring said unit to cause a delay of the incoming signals transmitted in digital form thereto before generating any corresponding digital output signals from said unit. Such a design of the arrangement makes it possible to compensate for the time consumed for the evaluation of an incoming signal.

The signal processing unit may suitably contain one or more FIR-filters which for instance may be based on PLD or FPGA solutions offering a high parallel processing capacity. However, the desired function of the signal processing unit may alternatively be obtained by utilizing a digital signal processor (DSP).

According to a preferred embodiment of the invention the signal processing unit may contain a FIR-filter which is arranged, in response to each sample X(k) of an incoming signal generated by the analog-to-digital converter, to generate an output signal Y(k) according to the equation

Y(k)=a₀·X(k)+a₁·X(k−1)+a₂·X(k−2) . . . +aₙ₋₁·X(k−(n−1))

where k designates the order number of the sample in question, a₀, a₁ . . . aₙ₋₁ consist of a set of multiplication coefficients selectable in dependence upon the result of the evaluation of the incoming signal effected by the evaluation means and previously stored in a memory contained in the arrangement.

The evaluation means may ccnsist of analog means which are arranged to receive the incoming signals in their original analog form. However, according to a favourable embodiment of the invention, the evaluation means may instead consist of reprogrammable digital evaluation means which are arranged to receive the incoming signals in a sampled digital form, preferably from the analog-to-digital converter connected between the input of the arrangement and the signal processing unit. The use of such evaluation means makes it possible, whenever so desired, to alter the criteria according to which the evaluation of the incoming signals is to be effected. In this case, the arrangement may preferably, be arranged to permit a remote controlled programming or reprogramming, respectively, of the evaluation means.

The evaluation means may suitably be arranged to determine whether an incoming signal satisfies one or more predetermined conditions and to cause the signal processing unit to deliver a digital output signal corresponding to the incoming signal only when said condition or each of said conditions, respectively, is satisfied. In this case, the evaluation means may be arranged to determine whether an incoming signal has a frequency falling within a predetermined permitted portion of the carrier frequency band previously mentioned. Moreover, the evaluation means may also be arranged to determine whether an incoming signal has an amplitude amounting to a predetermined lowest permitted value.

Finally, it should also be mentioned that the evaluation means may be arranged to deliver information, depending upon the result of the evaluation effected by said means, to storage means contained in the arrangement and from which said information can be fetched in to the headend.

Below the invention is further described with reference to the accompanying drawing which shows a block diagram of a noise reduction arrangement according to an embodiment of the invention, selected by way of example only, said arrangement being connected in a local cable TV network.

In the drawing, reference numeral 10 designates a portion of a local cable TV network which may consist of a local area network forming part of a cable TV system containing a headend 11, located at a substantial distance from the local network and serving as a communication central.

Network 10 contains a diplex filter 12 which is connected to headend 11 through a port A and to a plurality of subscriber lines 13 through a port B and which is arranged to permit a transmission of TV signals, radio signals and data signals in a downstream direction from headend 11 to subscriber lines 13 and subscriber outlets (not shown) connected to said lines within different predetermined carrier frequency bands.

An additional carrier frequency band b1 is utilized for the transmission of data signals in the return direction, i.e. in an upstream direction from lines 13 to headend 11, and for said purpose only. In order to facilitate a reduction of noise transmitted from network 10 within said carrier frequency band, diplex filter 12 is arranged via a port D to divert signals within carrier frequency band b1 incoming to port B from subscirber lines 13 to an input 14 of a noise reduction arrangement generally designated 15. From said arrangement, those of said signals which are permitted to pass through the arrangement can be fed via an output 16 to a port C of filter 12 in order then to be delivered to headend 11 via port A.

Noise reduction arrangement 15 comprises a reprogrammable digital signal processing unit 17 which is connected to input 14 via an analog-to-digital converter 19, controlled by a clock 18, and a parallel data bus 20 in order hereby to receive the analog signals incoming to input 14 in a sampled digital form. In order to obtain a sufficient resolution in the digital output signal from converter 19, each sample may suitably ccmprise at least 8 bits.

Furthermore, noise reduction arrangement 15 also comprises an evaluation unit 21 for evaluating the signals incoming to input 14 and delivering control signals, depending upon the result of said evaluation, to signal processing unit 17.

Unit 21 may consist of an analog evaluation unit which is connected directly to input 14 by means of line 22′ (shown dash-dotted) in order to receive the signals incoming tc said input in their original analog form.

However, unit 21 may alternatively consist of a reprogrammable digital evaluation unit which by means of a data bus 22″, shown in full lines, is connected to converter 19 in order hereby to receive the signals incoming to input 14 in a sampled digital form.

Signal processing unit 17 has for its purpose to generate digital output signals depending upon the current programming of said unit and the control signals supplied from evaluation unit 21 and corresponding to portions of the signals incoming to input 14 acceptable for forwarding to headend 11. From unit 17, these output signals are transmitted via a data bus 23 to a digital-to-analog converter 24 which is controlled by clock 18 and in which said signals are converted to corresponding analog signals then delivered from noise reduction arrangement 15 via output 16. Hereby, signal processing unit 17 acts as a blocking means which can permit or prevent a transmission at output 16 of output signals corresponding to the signals incoming at input 14 in dependence upon the evaluation of the incoming signals effected by unit 21.

In order to permit a remote controlled programming or reprogramming of signal processing unit 17 and also of evaluation unit 21, if the latter consists of a reprogrammable digital unit, there is provided a control unit 25 to which control orders of different kinds can be transmitted from headend 11 via a modem 26 connected to network 10.

The more detailed construction of units 17 and 21 may be varied in many different ways.

Signal processing unit 17 may preferably contain one or more FIR-filters and means for storing coefficient values preprogrammed by means of ccntrol unit 25 and means for momentarily loading the coefficient values proper to the control signals from evaluation unit 21.

Evaluation unit 21 may suitably contain a plurality of band-pass filters, having mutually different pass bands and by means of which frequency band b1 can be divided into different subbands, and a corresponding plurality of detectors connected each to one of said filters. These detectors may be utilized to determine whether a signal occurring within a certain subband has an amplitude amounting to a predetermined lowest permitted value and/or whether the front edge of the signal has a slope falling within a predetermined interval. If unit 21 consists of a digital unit, it may easily be reprogrammed in order to alter the pass bands of the different filters.

In order to facilitate a remote observation of the conditions in the local network, evaluation unit 21 may be arranged to deliver information about the result of the effected evaluation of the incoming signals to storage means contained in control unit 25. This information may then be fetched in to headend 11 via modem 26 when so desired.

The manner of operation of the noise reduction arrangement above described may be varied in many different ways. In the normal case, the arrangement may be programmed to permit signals incoming from the subscriber lines, having a certain lowest permitted amplitude and frequencies falling within one or more selected portions of frequency band b1, to pass through said unit. If signal types occur, not permitting the use of a level detection, the incoming signals may however be permitted to pass through the arrangement irrespectively of their amplitude.

Furthermore, the evaluation unit may be utilized to determine whether a signal incoming from a subscriber line is of a certain permitted modulation type and to permit a delivery of a corresponding signal to the headend only when this is the case. Since a determination of the modulation type may require a longer time than the longest delay that can be permitted in the noise reduction arrangement, one may consider to permit the signal to pass through the arrangement as soon as it has been ascertained that the carrier frequency falls within a permitted portion of frequency band b1 and then to interrupt the continued transmission of the signal immediately if it later on is found that the signal fails to exhibit a correct modulation.

Below follows a more detailed description of an arrangement of the kind shown in the drawing and above described, said arrangement being selected by way of example only.

Evaluation unit 21 is assumed to consist of an analog unit containing five band pass filters which divide frequency band b1 into five different pass bands, namely a first band b1_{A} covering the frequency range 5-9 MHz, a second band b1_{B} covering the frequency range 10-16 MHz, a third band b1_{C} covering the frequency range 17-26 MHz, a fourth band b1_{D} covering the frequency range 27-42 MHz, and a fifth band b1_{E} covering the frequency range 43-65 MHz. In this case, evaluation unit 21 also comprises five detectors which are connected each to one of said filters and which serve each to detect whether a valid message signal occurs within the pass band of the filter in question and to deliver corresponding ccntrol signals to signal processing unit 17, which acts as a controllable blocking means.

Signal processing unit 17 is assumed to contain a 15 taps FIR-filter to which the signals within frequency band b1 incoming to input 14 are supplied in a sampled digital form, and more particularly, in the form of an 10 bits parallel data signal consisting of a continuous stream of successive samples X which are generated at a frequency corresponding to the frequency of clock 18. This frequency may for instance amount to 150 MHz.

For each sample X, the FIR-filter generates a 10 bits output signal Y, formed by a combined multiplication and addition process effected by the FIR-filter. For each sample, this signal may be defined by the equation

Y(k)=a₀·X(k)+a₁·X(k−1)+a₂·X(k−2) . . . +a₁₄X(k−14)

where k designates the order number of the sample in question and a₀, a₁ . . . a₁₄ consist of multiplication coefficients stored in memories contained in unit 17. In practice, signal Y(k) is delayed some few clock cycles in relation to the time for the generation of sample X(k).

In order to facilitate different operation modes of unit 17 in dependence upon the control signals delivered from unit 21, a plurality of different sets of multiplication coefficients are stored in different memory banks in unit 17. Each set represents a certain predetermined operation mode. Within each set, the coefficient values are symmetrical, i.e. a₀=a₁₄, a₁=a₁₃, a₂=a₁₂, etcetera. Furthermore, each coefficient may suitably consist of 9 bits, namely 8 digit bits and 1 sign bit.

Unit 17 may for instance be arranged to operate according to any of the following three operation modes, namely as a high-pass filter permitting only signals within frequency band b1_{E}, i.e. 43-65 MHz, to pass therethrough, as an all-pass filter permitting signals within the entire frequency band b1, i.e. 5-65 MHz, to pass therethrough and as a blocking filter which blocks the entire frequency band b1.

The firstmentioned one of the three above operation modes may be utilized if the evaluation unit 21 detects the occurrance of a valid message signal only within frequency band b1_{E}.This operation mode can suitably be obtained by utilizing the following set of coefficients, namely a₀=a₁₄=1, a₁=a₁₃=5, a₂=a₁₂=14, a₃=a₁₁=23, a₄=a₁₀=15, a₅=a₉=−19, a₆=a₈=−64, a₇=127. These coefficient values have been selected in order to ensure that within frequency band b1 _{E} there will not occur any substantial ripple nor any substantial variations in the delay caused by the FIR-filter.

The second one of said operation modes may be utilized if unit 21 detects a simultaneous occurrance of valid message signals within more than one of the different frequency bands b1_{A} through b1_{E} for instance within frequency bands b1_{B}, b1_{C} and b1_{E}. In order to achieve said operation mode, the following coefficient values may preferably be utilized, namely a₀=a₁₄=0, a₁=a₁₃=0, a₂=a₁₂=0, a₃=a₁₁=0, a₄=a₁₀=0, a₅=a₉=0, a₆=a₈=0, a₇=212. By selecting the coefficient values in this manner, it is possible to ensure that the delay and the amplification in the FIR-filter of a signal within frequency band b1_{E} will not be changed when shifting from the firstmentioned to the second operation mode or inversely.

The third one of the above operation modes may be utilized when no valid message signal at all occurs within frequency band b1. This operation mode may naturally be obtained by utilizing a set of coefficients where all coefficients a₀ through a₁₄ have the value 0.

In the example above described it has been assumed that signal processing unit 17 contains a symmetrical FIR-filter. Said unit may however alternatively contain an unsymmetrical FIR-filter or an IIR-filter. However, a symmetrical FIR-filter offers the advantage of making it easy to ensure that the delay distorsion and the amplitude variation of a signal within a pass band common to two or more operation modes will be very low when shifting from one of said operation modes to another mode.

Moreover, it has been assumed that evaluation unit 21 ccnsists of an analog unit. Said unit may however instead consist of a digital unit containing a number of FIR-filters or IIR-filters acting as band-pass filters and a corresponding number of envelope detectors connected each to one of said filters.

The invention is not restricted to the embodiment above described and shown in the drawing. Instead, many other embodiments are feasible within the scope of the invention as defined in the following claims.

1. Arrangement for the reduction of noise transmitted from a local cable TV network (10) within a carrier frequency band serving for the transmission of signals in the return direction from subscriber lines (13) contained in said network (10) to a headend (11) connected to the network, said arrangement comprising an input (14) intended to be connected to the subscriber lines (13), an output (16) intended to be connected to the headend (11), means (21) for evaluating signals incoming at the input (14), and blocking means (17) controllable by said evaluation means (21) and arranged to permit or prevent a transmission of signals corresponding to the incoming signals at the output (16) in dependence upon the evaluation of the incoming signals effected by the evaluation means (21), characterized in that said blocking means are formed by a reprogrammable digital signal processing unit (17), which is connected to the input (14) via an analog-to-digital converter (19) in order hereby to receive the incoming signals in a sampled digital form and which is arranged to generate digital output signals corresponding to portions of the incoming signals, depending upon the existing programming of the signal processing unit (17) and the result of the evaluation of the incoming signals effected by the evaluation means (21), and to deliver said digital output signals to a digital-to-analog converter (24) connected to the output (16).

2. Arrangement according to claim 1, characterized in that it is arranged to permit a remote controlled programming or reprogramming, respectively, of the signal processing unit (17).

3. Arrangement according to claim 1 or 2, characterized in that the signal processing unit (17) is capable of acting as a frequency converter that can cause a change in the carrier frequency of an incoming signal during the passage of said signal in digital form through said unit.

4. Arrangement according to any of the preceding claims, characterized in that the signal processing unit (17) is arranged to cause a delay of the incoming signals transmitted in digital form thereto before generating any corresponding digital output signals from said unit.

5. Arrangement according to any of the preceding claims, characterized in that the signal processing unit (17) contains one or more FIR-filters.

6. Arrangement according to claim 5, characterized in that the signal processing unit (17) contains a FIR-filter which is arranged, in response to each sample X(k) of an incoming signal generated by the analog-to-digital converter, to generate an output signal Y(k) according to the equation
Y(k)=a₀·X(k)+a₁·X(k−1)+a₂·X(k−2) . . . +aₙ₋₁·X(k−(n−1))
where k designates the order number of the sample in question, a₀, a₁. . . aₙ₋₁ consist of a set of multiplication coefficients selectable in dependence upon the result of the evaluation of the incoming signal effected by the evaluation means and previously stored in a memory contained in the arrangement.

7. Arrangement according to any of the preceding claims, characterized in that the evaluation means (21) consist of analog means which are arranged to receive the incoming signals in their original analog form.

8. Arrangement according to any of claims 1-6, characterized in that the evaluation means (21) consist of reprogrammable digital means which are arranged to receive the incoming signals in a sampled digital form.

9. Arrangement according to claim 8, characterized in that it is arranged to permit a remote controlled programming or reprogramming, respectively, of the evaluation means (21).

10. Arrangement according to any of claims 7-9, characterized in that the evaluation means (21) are arranged to determine whether an incoming signal satisfies one or more predetermined conditions and to cause the signal processing unit (17) to deliver a digital output signal corresponding to the incoming signal only when said condition or each of said conditions, respectively, is satisfied.

11. Arrangement according to claim 10, characterized in that the evaluation means (21) are arranged to determine whether an incoming signal has a frequency falling within a predetermined permitted portion of said carrier frequency band.

12. Arrangement according to claim 10 or 11, characterized in that the evaluation means (21) are arranged to determine whether an incoming signal has an amplitude amounting to a predetermined lowest permitted value.

13. Arrangement according to any of claims 7-12, characterized in that the evaluation means (21) are arranged to deliver information, depending upon the result of the evaluation effected by said means, to storage means (25) contained in the arrangement and from which said information can be fetched in to the headend (11).
